(19) United States
(12) Patent Application Publication
(10) Pub. No.: US 2019/0136817 A1
(43) Pub. Date: May 9, 2019

(54) METHOD FOR ASSISTING THE STARTING OF A MOTOR-DRIVEN VEHICLE

(71) Applicant: ZF Friedrichshafen AG, Friedrichshafen (DE)

(72) Inventors: Hans PILZWEGER, Neuhaus am Inn (DE); Alexander STÖBICH, Wegscheid (DE)

(21) Appl. No.: 16/183,799

(22) Filed: Nov. 8, 2018

(30) Foreign Application Priority Data
Nov. 9, 2017 (DE) 10 2017 219 971.7

(51) Int. Cl. F02N 11/08; F16H 63/50; F16H 59/18

(52) U.S. Cl. CPC F02N 11/0851; F16H 2061/0422; F16H 59/18; F16H 63/502

(57) ABSTRACT

A method for starting a vehicle having a start-stop system, a bake pedal for braking, a pressure controlled clutch, an accelerator for setting an engine speed, and a control unit for controlling engine operation. The method including detecting brake release after a start-stop process; determining the clutch pressure; determining a required torque from the determined pressure based on a stored pressure-torque characteristic; determining the necessary engine speed requirement from the determined required torque based on a stored characteristic engine torque curve; inquiring whether the necessary speed requirement exceeds the available torque at the current engine speed; if not, then the engine speed is not increased; if so, inquiring whether the necessary speed requirement exceeds the accelerator requested speed; if not, increasing the engine speed with the engine control unit to the determined speed requirement; and if so, increasing the engine speed to the maximum set at the accelerator.

This application claims priority from German patent application serial no. 10 2017 219 971.7 filed Nov. 9, 2017.

### FIELD OF THE INVENTION

The invention relates to a method for assisting in driving-off an engine-driven vehicle having a start-stop system, which vehicle can be braked by actuating a brake pedal, having a main clutch to which a modulation pressure can be applied, having an accelerator for manually setting a speed of the engine and having an engine control unit for controlling the operation of the engine.

### BACKGROUND OF THE INVENTION

During a driving-off procedure, the driver must manually increase the engine speed or engine torque to allow the engine to operate under load, so that the engine does not stall when starting uphill on an incline. Otherwise, the vehicle might roll backwards and hit other vehicles.

### SUMMARY OF THE INVENTION

The invention therefore addresses the problem of providing a method for assisting in driving off an engine-driven vehicle of the type mentioned, which prevents the engine from stalling when starting under load.

This problem is solved by the following steps according to the invention,
detecting the release of the brake pedal after a start-stop process,
determine the modulation pressure of the main clutch,
determine a required torque from the determined modulation pressure on the basis of a stored modulation pressure—torque characteristic.
determine the necessary speed requirement of the engine from the determined required torque based on a stored characteristic torque curve of the engine,
inquire whether the necessary speed requirement is greater than the available torque at the current engine speed of the engine,
if not, then no actuation to increase the speed of the engine,
if so, inquire whether the necessary speed requirement is greater than the requested speed according to the position of the accelerator,
if not, then the engine control unit increases the speed of the engine to the determined speed requirement of the engine,
if so, then the engine control unit increases the speed of the engine to the maximum speed of the engine set at the accelerator.

This design automatically detects if the speed during the starting process must be increased to prevent the engine from stalling. The driver then no longer has to intervene manually, as, if required, the engine speed is automatically increased during driving off.

For this purpose, the release of the brake pedal can be detected in a simple manner from the opening of a brake light switch of a brake light.

### BRIEF DESCRIPTION OF THE DRAWINGS

An exemplary embodiment of the invention is illustrated in the drawings and will be described in more detail below. In the drawings:

FIG. 1 shows a program flowchart of a method for assisting in driving off of an engine-driven vehicle having a start-stop system

FIG. 2 shows a diagram of the characteristic curve of the modulation pressure as a function of the time of a main clutch of the method according to FIG. 1

FIG. 3 shows a diagram of the characteristic curve of the torque of an engine as a function of the modulation pressure according to FIG. 2

FIG. 4 shows a graph of the characteristic curve of the torque of the engine as a function of the speed of the engine of the method according to FIG. 1.

### DETAILED DESCRIPTION OF THE PREFERRED EMBODIMENTS

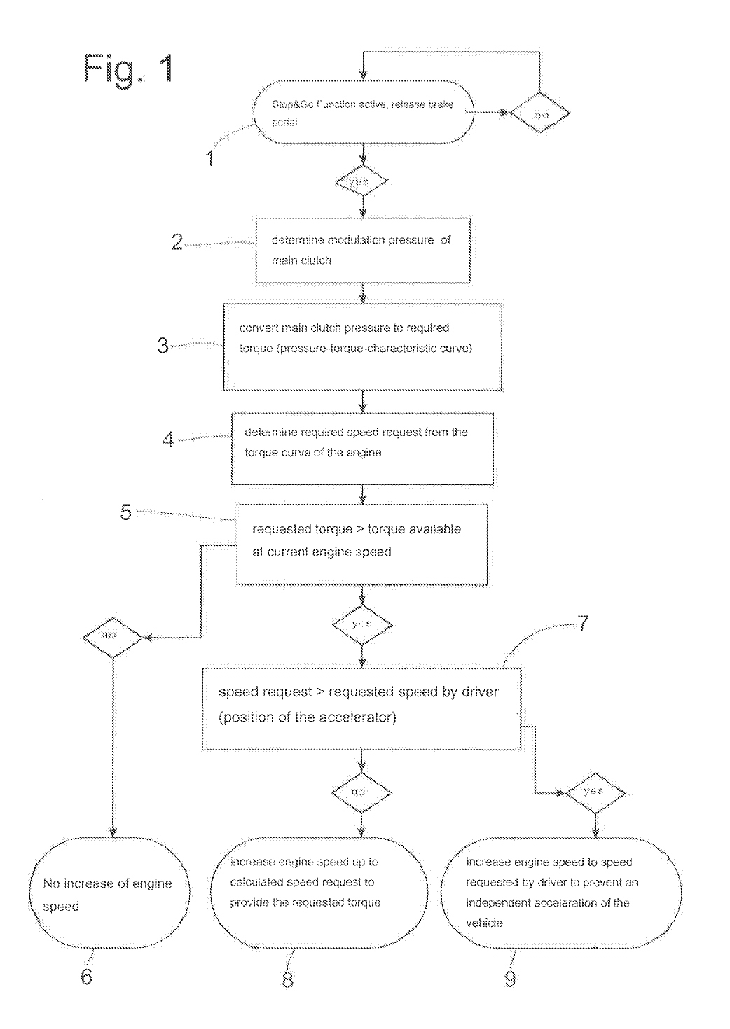

According to the program flow chart shown in FIG. 1, the method of assisting in the driving-off of an engine-driven vehicle having a start-stop system is triggered in step 1 by releasing a previously pressed brake pedal after a start-stop operation, i.e. the brake is released.

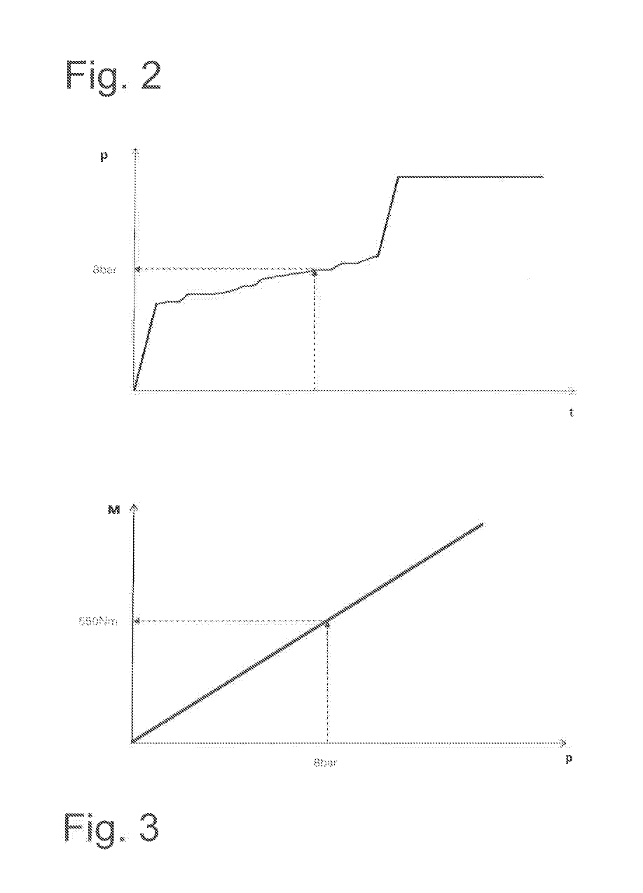

If the release of the brake pedal has been detected, in a step 2 the modulation pressure of a main clutch is determined from a characteristic of the modulation pressure stored in an engine control unit of the engine as a function of the time of a main clutch (FIG. 2). In the present example, a current modulation pressure of 8 bar is detected.

Then, in a step 3, the maximum transmittable torque of the engine is determined from the determined modulation pressure of 8 bar based on a characteristic of the engine torque as a function of the modulation pressure (FIG. 3) stored in the engine control unit; in the present example the maximum transmittable torque of the engine is 550 Nm.

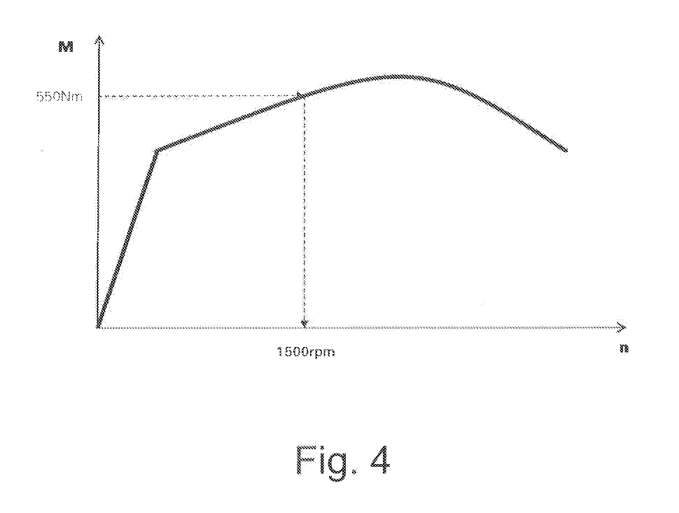

In a step 4, the speed of the engine, which is required for the maximum transmittable torque of the engine, is determined from a characteristic of the engine torque as a function of the engine speed (FIG. 4), stored in the engine control unit. At a determined torque of 550 Nm, a speed of 1500 rpm results.

Now, in a step 5, a check is performed to determine whether the required torque of 550 Nm is greater or lower than the torque available at the current speed of 1500 rpm.

If the required torque of 550 Nm is lower than the torque available at the current speed of 1500 rpm, then in a step 6, the engine control unit does not actuate the engine to increase the speed of the engine.

If the required torque of 550 Nm is greater than the torque available at the current speed of 1500 rpm, in a step 7 a check is performed to determine whether the necessary speed requirement is greater or lower than the requested speed corresponding to the position of the accelerator.

If the necessary speed requirement is lower than the requested speed corresponding to the position of the accelerator, then in a step 8, the engine control unit increases the speed of the engine to the determined speed requirement of the engine to provide the required torque.

If the necessary speed requirement is greater than the requested speed corresponding to the position of the accelerator, in a step 9, the engine control unit increases the engine speed at most to a speed specified by the driver by means of the accelerator position. In this way, an independent acceleration of the vehicle is prevented.

Based on the method according to the invention, the engine speed is adjusted during start-up such that the currently transmissible torque of the engine from the main clutch is available at any time.

### REFERENCE NUMERALS

1 Step 1
2 Step 2
3 Step 3
4 Step 4
5 Step 5
6 Step 6
7 Step 7
8 Step 8
9 Step 9

1-2. (canceled)

3. A method for assisting starting of an engine-driven vehicle having a start-stop system, which can be braked by actuating a brake pedal, having a main clutch to which a modulation pressure can be applied, having an accelerator for manually setting a speed of an engine, and having an engine control unit for controlling operation of the engine, the method comprising:
detecting a release of the brake pedal after a start-stop process,
determining the modulation pressure of the main clutch,
determining a required torque from the determined modulation pressure on a basis of a stored modulation pressure-torque characteristic,
determining a necessary speed requirement of the engine from the determined required torque based on a stored characteristic torque curve of the engine,
inquiring whether the necessary speed requirement is greater than an available torque at a current engine speed of the engine,
if not, then no actuation to increase the speed of the engine,
if so, inquiring whether the necessary speed requirement is greater than a requested speed according to a position of an accelerator,
if not, increasing, with the engine control unit, the speed of the engine to the determined speed requirement of the engine, and
if so, increasing, with the engine control unit, the speed of the engine to a maximum speed of the engine set at the accelerator.

4. The method according to claim 3, further comprising detecting the release of the brake pedal from the opening of a brake light switch of a brake light.

5. A method for assisting a starting of an engine-driven vehicle having a start-stop system, a brake which is actuatable by a brake pedal, a main clutch which is actuatable by applying a modulation pressure thereto, an accelerator for manually setting a speed of the engine, and an engine control unit which controls operation of the engine, the method comprising:
detecting, with the engine control unit, a release of the brake pedal after a start-stop process;
determining, with the engine control unit, the modulation pressure of the main clutch;
determining a required torque from the determined modulation pressure based on a stored modulation pressure-torque characteristic, and the required torque being determined with the engine control unit;
determining a necessary engine speed, which is required for maximum transmission of engine torque, from the determined required torque based on a stored characteristic torque curve of the engine, and the necessary engine speed being determined with the engine control unit;
comparing, with the engine control unit, the determined required torque to torque available at a current engine speed;
maintaining the current engine speed, via the engine control unit, if the determined required torque is less than the torque available at the current engine speed;
comparing, via the engine control unit, the determined necessary engine speed to a driver requested engine speed which is based on an accelerator pedal position, if the determined required torque is greater than the torque available at the current engine speed;
increasing, via the engine control unit, the speed of the engine up to the necessary engine speed, if the determined necessary engine speed is less than the driver requested engine speed; and
increasing, via the engine control unit, the speed of the engine up to the driver requested engine speed, if the determined necessary engine speed is greater than the driver requested engine speed.
